(19) United States
(12) Patent Application Publication
(10) Pub. No.: US 2026/0302872 A1
(43) Pub. Date: Oct. 1, 2026

(54) OIL VACUUM SHAFT

(71) Applicant: Schaeffler Technologies AG & Co. KG, Herzogenaurach (DE)

(72) Inventors: Jessica Sampieri, Puebla (MX); Rodrigo Bahena, Puebla (MX); David Arellano, Puebla (MX); Franklin May, Puebla (MX); Irving Azael Escamilla, Huejotzingo (MX)

(73) Assignee: Schaeffler Technologies AG & Co, KG, Herzogenaurach (DE)

(21) Appl. No.: 19/092,087

(22) Filed: Mar. 27, 2025

(51) Int. Cl. H02K 5/20; H02K 7/00; H02K 9/19

(52) U.S. Cl. CPC H02K 5/203; H02K 7/003; H02K 9/19

(57) ABSTRACT

A drive unit including an electric motor having a stator and a rotor, and at least one cooling fluid flow path for distributing oil through the drive unit including to at least one of the rotor or the stator. The rotor includes a hollow rotor shaft, the hollow rotor shaft has a passageway forming at least a part of the at least one cooling fluid flow path. An impeller is supported within a portion of the passageway of the rotor shaft, the impeller is configured to rotate with the rotor shaft.

### TECHNICAL FIELD

The disclosure relates to cooling and lubrication of drive components of an electric or hybrid vehicle, and more particularly to cooling and/or lubrication of an e-axle of a hybrid or electric vehicle

### BACKGROUND

In general, e-axles are known structures used in electric and hybrid vehicles. The components of the e-axle, including the electric motor and transmission elements, typically are cooled and lubricated with oil. This is typically done by flooding the cooling areas of the motor with oil from the drive system unit or actively using a pump to distribute the oil. In actively cooled systems, a pump is typically provided at the beginning of the oil paths to push the oil throughout the system. Conventional pumps in actively cooled system introduce increased costs and complexity to the system.

### SUMMARY

In accordance with one aspect, a drive unit comprises an electric motor having a stator and a rotor, and at least one cooling fluid flow path for distributing oil through the drive unit including to at least one of the rotor or the stator. The rotor includes a hollow rotor shaft, the hollow rotor shaft has a passageway forming at least a part of the at least one cooling fluid flow path. An impeller is supported within a portion of the passageway of the rotor shaft, the impeller configured to rotate with the rotor shaft to draw cooling fluid into the passageway.

The hollow rotor shaft and the impeller can define a rotor shaft assembly. The impeller can include a bladed disc. The bladed disc can include a hub, an outer ring, and a plurality of blades extending between the hub and the outer ring. The bladed disc can be press-fit into the hollow rotor shaft. The impeller can be located axially adjacent a rotor shaft inlet. The impeller can include a bladed disc, and at least one blade of the bladed disc can have an angle of 25 degrees relative to an axis of rotation of the bladed disc.

In accordance with another aspect, an electric motor comprises a stator, a rotor, and at least one cooling fluid flow path for distributing oil through to at least one of the rotor or the stator. The rotor includes a hollow rotor shaft, the hollow rotor shaft having a passageway forming at least a part of the at least one cooling fluid flow path, and an impeller is supported within a portion of the passageway of the rotor shaft, the impeller configured to rotate with the rotor shaft to draw cooling fluid into the passageway.

The hollow rotor shaft and the impeller can define a rotor shaft assembly. The impeller can include a bladed disc. The bladed disc can include a hub, an outer ring, and a plurality of blades extending between the hub and the outer ring. The bladed disc can be press-fit into the hollow rotor shaft. The impeller can be located axially adjacent a rotor shaft inlet. At least one blade of the bladed disc can have an angle of 25 degrees relative to an axis of rotation of the bladed disc.

In accordance with another aspect, a rotor shaft assembly comprises a rotor shaft having a hollow interior, and an impeller supported within the hollow interior of the rotor shaft for rotation therewith.

The impeller can be press-fit into the hollow interior of the rotor shaft. The impeller can be located axially adjacent a rotor shaft inlet. The impeller can include a bladed disc. The bladed disc can include a hub, an outer ring, and a plurality of blades extending between the hub and the outer ring. At least one blade of the bladed disc can have an angle of 25 degrees relative to an axis of rotation of the bladed disc.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of an exemplary drive unit including an electric motor in accordance with the present disclosure.

FIG. 2 is a perspective view of an exemplary rotor shaft assembly including a bladed disc in accordance with present disclosure.

FIG. 3 is a perspective view of the bladed disc of FIG. 2.

FIG. 4 is a perspective view of another bladed disc in accordance with the present disclosure.

FIG. 5 is a front elevation view of the bladed disc of FIG. 4.

FIG. 6 is a cross-sectional view taken along the line 6-6 in FIG. 5.

FIG. 7 is a cross-sectional view taken along the line 7-7 in FIG. 5.

### DETAILED DESCRIPTION

Certain terminology is used in the following description for convenience only and is not limiting. The words "front," "rear," "upper" and "lower" designate directions in the drawings to which reference is made. The words "inwardly" and "outwardly" refer to directions toward and away from the parts referenced in the drawings. “Axially” refers to a direction along the axis of a shaft. A reference to a list of items that are cited as "at least one of a, b, or c" (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

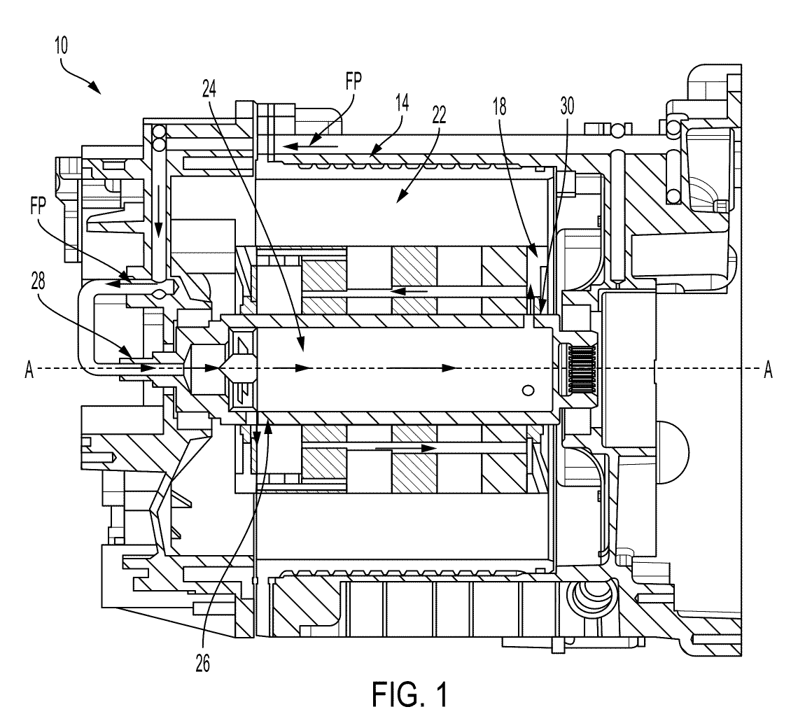

Referring to the Figures, and initially to FIG. 1, an exemplary electric drive unit is illustrated and identified generally by reference numeral 10. The drive unit 10 includes an electric motor 14 having a rotor 18 and a stator 22. Exemplary cooling fluid flow paths FP are identified by a plurality of arrows extending axially in a first direction through a central passageway 24 of a hollow rotor shaft 26 from a rotor shaft inlet 28 and then radially outwardly through a rotor shaft outlet 30, axially in a second direction long portions of the rotor 18 and stator 22, and radially inwardly back towards the rotor shaft 26 to the rotor shaft inlet 28 where the oil reenters the rotor shaft 26. It will be appreciated that aspects of the present disclosure can be utilized in connection with any cooling fluid flow path for enhancing oil flow and/or distribution. It will be appreciated that the drive unit 10 is exemplary in nature and aspects of the present disclosure are applicable to a wide range of drive unit and/or electric machine configurations.

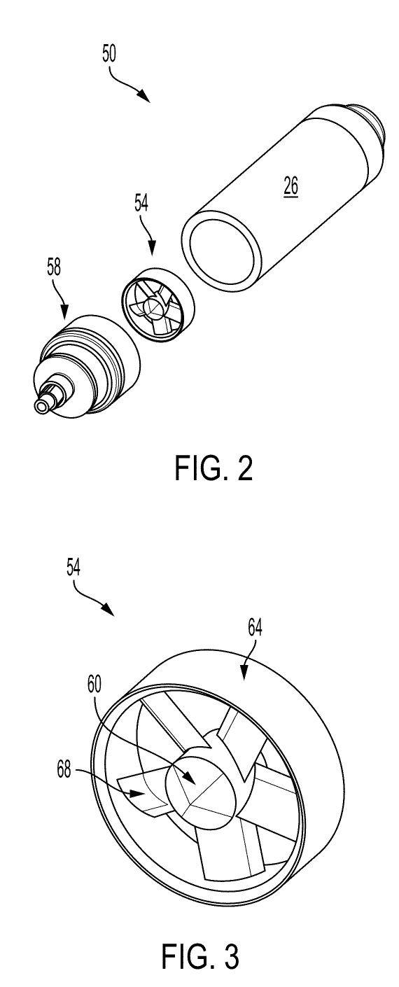

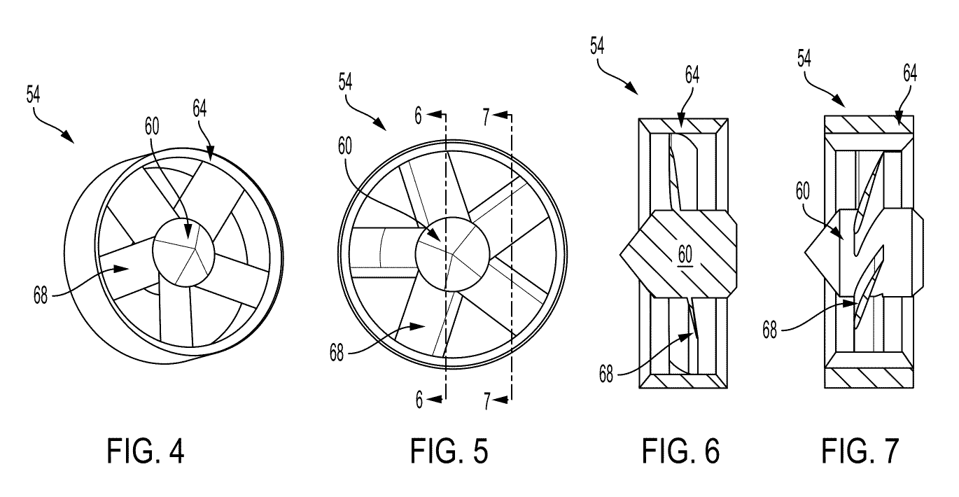

With additional reference to FIGS. 2-7, a rotor shaft assembly 50 comprises the rotor shaft 26, a bladed inner disc (impeller) 54 and a rotor shaft end cap portion 58. In FIG. 2, the rotor shaft 26 is illustrated as two components to show the manner in which the bladed inner disc 54 is supported therein, however, in practice the rotor shaft will typically be a unitary, one-piece component. The bladed inner disc 54 is adapted to be received within a hollow interior of the rotor shaft 26 (e.g., the central passageway 24). In some embodiments, the bladed inner disc 54 is press-fit into the rotor shaft 26. It will be appreciated that the bladed inner disc 54 is configured to rotate with the rotor shaft 26 about an axis of rotation A-A.

The bladed inner disc 54 includes a hub 60, an outer ring 64 and a plurality of blades 68. In the illustrated example, there are a total of five blades 68 with a 25 degree angle relative to an axis of rotation of the bladed inner disc 54. It will be appreciated that other configurations of the bladed inner disc 54 can be utilized without departing from the scope of the present disclosure. For example, the number of blades and/or blade angle can be different depending on a particular application.

In operation, the bladed inner disc 54 will start to work once the rotor shaft 26 starts to rotate. The bladed inner disc 54 works as an axial pump increasing the velocity of the stationary air in the oil paths FP to lower its pressure. Lowering the pressure of the air results in a pressure difference within the cooling fluid flow paths (e.g., relative to an oil sump) thereby generating a vacuum effect. The vacuum effect generated by the bladed inner disc 54 creates suction in the oil paths FP upstream of the bladed inner disc 54 that draws oil into the rotor shaft 26. Contrary to conventional arrangements that utilize an oil pump to push the oil through the cooling fluid flow paths, the bladed inner disc 54 acts to suck air to pull the oil into the central passageway 24 where the oil is then distributed radially outwardly via centrifugal force generating by the spinning rotor shaft 26. In the exemplary embodiment, the bladed disc 54 is located adjacent the rotor shaft inlet 28.

Simulation testing has shown that the bladed inner disc 54 can increase oil flow in the oil paths FP by 45% or more. In addition, the bladed inner disc 54 aids in distributing the oil to the radially inner surface of the rotor shaft 26 defining the passageway 24 for more uniform wetting of the rotor shaft 26. This feature helps heat transfer from the rotor shaft to the oil.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 Drive Unit

14 Electric Motor

18 Rotor

22 Stator

24 Central Passageway

26 Rotor Shaft

28 Rotor Shaft Inlet

30 Rotor Shaft Outlet

50 Rotor Shaft Assembly

58 Rotor Shaft End Portion

60 Hub

64 Outer Ring

68 Blades

What is claimed is:

1. A drive unit comprising:
an electric motor having a stator and a rotor; and
at least one cooling fluid flow path for distributing oil through the drive unit including to at least one of the rotor or the stator;
wherein the rotor includes a hollow rotor shaft, the hollow rotor shaft having a passageway forming at least a part of the at least one cooling fluid flow path; and
wherein an impeller is supported within a portion of the passageway of the rotor shaft, the impeller configured to rotate with the rotor shaft for rotation within the passageway of the rotor shaft.

2. The drive unit according to claim 1, wherein the hollow rotor shaft and the impeller define a rotor shaft assembly.

3. The drive unit according to claim 1, wherein the impeller comprises a bladed disc.

4. The drive unit according to claim 3, wherein the bladed disc includes a hub, an outer ring, and a plurality of blades extending between the hub and the outer ring.

5. The drive unit according to claim 4, wherein the bladed disc is press-fit into the hollow rotor shaft.

6. The drive unit according to claim 1, wherein the impeller is located axially adjacent a rotor shaft inlet.

7. The drive unit according to claim 1, wherein the impeller comprises a bladed disc, and wherein at least one blade of the bladed disc has an angle of 25 degrees relative to an axis of rotation of the bladed disc.

8. An electric motor comprising:
a stator;
a rotor; and
at least one cooling fluid flow path for distributing oil through to at least one of the rotor or the stator;
wherein the rotor includes a hollow rotor shaft, the hollow rotor shaft having a passageway forming at least a part of the at least one cooling fluid flow path; and
wherein an impeller is supported within a portion of the passageway of the rotor shaft, the impeller configured to rotate with the rotor shaft to draw fluid into the passageway.

9. The electric motor according to claim 8, wherein the hollow rotor shaft and the impeller define a rotor shaft assembly.

10. The electric motor according to claim 8, wherein the impeller comprises a bladed disc.

11. The electric motor according to claim 10, wherein the bladed disc includes a hub, an outer ring, and a plurality of blades extending between the hub and the outer ring.

12. The electric motor according to claim 11, wherein the bladed disc is press-fit into the hollow rotor shaft.

13. The electric motor according to claim 8, wherein the impeller is located axially adjacent a rotor shaft inlet.

14. The electric motor according to claim 8, wherein the impeller comprises a bladed disc, and wherein at least one blade of the bladed disc has an angle of 25 degrees relative to an axis of rotation of the bladed disc.

15. A rotor shaft assembly comprising:
a rotor shaft having a hollow interior; and
an impeller supported within the hollow interior of the rotor shaft for rotation therewith.

16. The rotor shaft assembly according to claim 15, wherein the impeller is press-fit into the hollow interior of the rotor shaft.

17. The rotor shaft assembly according to claim 16, wherein the impeller is located axially adjacent a rotor shaft inlet.

18. The rotor shaft assembly according to claim 15, wherein the impeller comprises a bladed disc.

19. The rotor shaft assembly according to claim 18, wherein the bladed disc includes a hub, an outer ring, and a plurality of blades extending between the hub and the outer ring.

20. The rotor shaft assembly according to claim 19, wherein at least one blade of the bladed disc has an angle of 25 degrees relative to an axis of rotation of the bladed disc.
